(19) United States
(12) Patent Application Publication
(10) Pub. No.: US 2026/0186974 A1
(43) Pub. Date: Jul. 2, 2026

(54) PHYSICAL PREFETCH

(71) Applicant: Micron Technology, Inc., Boise, ID (US)

(72) Inventors: David Aaron Palmer, Boise, ID (US); Jonathan S. Parry, Boise, ID (US); Giuseppe Cariello, Boise, ID (US)

(21) Appl. No.: 19/427,999

(22) Filed: Dec. 19, 2025

Related U.S. Application Data
(60) Provisional application No. 63/739,037, filed on Dec. 26, 2024.

(51) Int. Cl. G06F 12/0862

(52) U.S. Cl. CPC G06F 12/0862; G06F 2212/6028

(57) ABSTRACT

Methods, systems, and devices for physical prefetch are described. A memory system may prefetch data from physical addresses that are sequential to a physical address that has recently been read by the memory system. For example, the memory system may determine that a rate of access for a virtual block exceeds a threshold, and the memory system may prefetch the physically sequential data in response to the rate of access exceeding the threshold. In some examples, the memory system may receive a command to read a logical block address corresponding to a first physical address. The memory system may determine that the rate of access to the virtual block exceeds the threshold. The memory system may identify one or more second physical addresses that are sequential to the first physical address, and the memory system may transfer data from the one or more second physical addresses to a buffer.

### CROSS REFERENCE

The present Application for Patent claims priority to U.S. Patent Application No. 63/739,037 by Palmer et al., entitled “PHYSICAL PREFETCH,” filed Dec. 26, 2024, which is assigned to the assignee hereof, and which is expressly incorporated by reference in its entirety herein.

### TECHNICAL FIELD

The following relates to one or more systems for memory, including physical prefetch.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports physical prefetch in accordance with examples as disclosed herein.

FIG. 2 shows an example of an architecture that supports physical prefetch in accordance with examples as disclosed herein.

FIG. 3 shows an example of a process that supports physical prefetch in accordance with examples as disclosed herein.

FIG. 4 shows a block diagram of a memory system that supports physical prefetch in accordance with examples as disclosed herein.

FIG. 5 shows a flowchart illustrating a method or methods that support physical prefetch in accordance with examples as disclosed herein.

### DETAILED DESCRIPTION

In some memory systems, data from a host system may be written to a memory device such that sequential data is stored in sequential physical addresses in memory. Sequential data may refer to data that is stored in sequentially indexed addresses. In some cases, information may be stored in sequentially-indexed logical addresses, sequentially-indexed physical addresses or both. Sequential data may be written together, or at a same time, by the host system. In some cases, the sequentiality of an address space may be disrupted while the sequentiality of a different address space is maintained. For example, the logical address space may cease to be sequential for a chunk of information due to operations performed by the host system. However, the physical address space may continue to be sequential because the information didn't actually change location in a memory device. Though the sequential data may be stored in sequential physical addresses in the memory device, logical block addresses (LBAs) associated with the sequential data may be fragmented (e.g., non-sequential). A fragmented logical address space may result in various inefficiencies for memory access. For example, the host system may frequently request reads to the data (which is sequential in the physical address space, but not in the logical address space), and the memory system may load logical-to-physical (L2P) mapping information from the memory device to an L2P cache of the memory system to determine physical addresses where the requested data is stored. However, the L2P cache may be too small to store a sufficient amount of L2P information for accessing the requested data, and the memory system may experience cache misses during reads of multiple non-sequential LBAs in the fragmented logical address space, which may result in relatively slow memory access speeds, latencies, and inefficient usage of processing resources.

In accordance with examples described herein, the memory system may prefetch data from physical addresses that are sequential to a physical address that has recently been read by the memory system. For example, the memory system may determine that a rate of access (e.g., a quantity of read operations over a duration) for a virtual block satisfies a threshold, and the memory system may prefetch data from physical addresses that are sequential with the physical addresses that have already been accessed in response to the rate of access satisfying the threshold. In some examples, the memory system may receive a command to read an LBA corresponding to a first physical address. The memory system may determine that, responsive to receiving the command, the rate of access to the virtual block satisfies the threshold. The memory system may determine one or more second physical addresses that are sequential to the first physical address, and the memory system may transfer data from the one or more second physical addresses (e.g., in a non-volatile memory device such as a NAND device) to a buffer (e.g., a volatile memory such as an SRAM) in response to the rate of access to the virtual block satisfying the threshold. After prefetching the data from the physical addresses into the buffer, the memory system may receive subsequent read commands that request the data that has been prefetched, and the memory system may output the data from the buffer to the host system. Outputting data from the buffer may take less time than retrieving the data from the NAND device. In such cases, prefetching the data may cause the memory system to respond to read commands faster and thus improve performance of the memory system. In some examples, outputting the data from the buffer may be in response to receiving a read command from the host system and determining that data requested by the read command is present in the buffer. By predicting that sequential physical addresses are likely to be read by the host system and loading these physical addresses into the buffer, the memory system may support increased memory access speeds as a result of faster access speeds from the buffer relative to access speeds from one or more memory devices.

In addition to applicability in memory systems as described herein, techniques for physical prefetch may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits.

Features of the disclosure are illustrated and described in the context of systems, devices, and circuits. Features of the disclosure are further illustrated and described in the context of architectures, processes, block diagrams, and flowcharts.

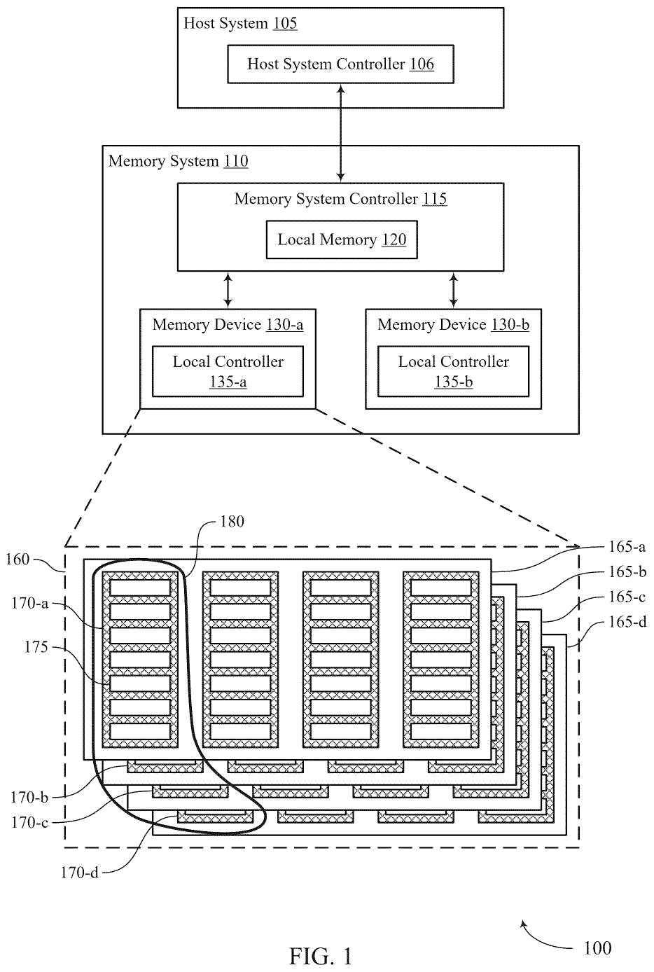

FIG. 1 shows an example of a system 100 that supports physical prefetch in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some memory systems 110, data from a host system 105 may be written to a memory device 130 such that sequential data is stored in sequential physical addresses in memory. Sequential data may refer to data that is stored in sequentially indexed addresses. In some cases, information may be stored in sequentially-indexed logical addresses, sequentially-indexed physical addresses or both. Sequential data may be written together, or at a same time, by the host system. In some cases, the sequentiality of an address space may be disrupted while the sequentiality of a different address space is maintained. For example, the logical address space may cease to be sequential for a chunk of information due to operations performed by the host system. However, the physical address space may continue to be sequential because the information didn't actually change location in a memory device. Though the sequential data may be stored in sequential physical addresses in the memory device 130, LBAs associated with the sequential data may be fragmented (e.g., non-sequential). A fragmented logical address space that is used to store data that is sequential in the physical address space may result in various inefficiencies for memory access. For example, the host system 105 may frequently request reads to the data, and the memory system 110 may load the L2P mapping information from the memory device 130 (e.g., a NAND device) to an L2P cache (e.g., local memory 120) of the memory system 110 to determine physical addresses where the requested data is stored. However, the L2P cache may be too small to store a sufficient amount of L2P information for accessing the requested data, and the memory system 110 may experience cache misses during reads of multiple non-sequential LBAs in the fragmented logical address space, which may result in relatively slow memory access speeds, latencies, and inefficient usage of processing resources.

In accordance with examples described herein, the memory system 110 may prefetch data from physical addresses that are sequential to a physical address that has recently been read by the memory system 110. For example, the memory system 110 may determine that a rate of access (e.g., a quantity of read operations over a duration) for a virtual block 180 satisfies (e.g., exceeds) a threshold, and the memory system 110 may prefetch the physically sequential data in response to the rate of access satisfying the threshold. In some examples, the memory system 110 may receive a command to read an LBA corresponding to a first physical address. The memory system 110 may determine that, responsive to receiving the command, the rate of access to the virtual block 180 satisfies the threshold. The memory system 110 may determine one or more second physical addresses that are sequential to the first physical address, and the memory system 110 may transfer data from the one or more second physical addresses (e.g., from a memory device 130) to a buffer (e.g., a read lookahead buffer, local memory 120) in response to the rate of access to the virtual block 180 exceeding the threshold. After prefetching the data from the physical addresses into the buffer, the memory system 110 may receive subsequent read commands that request the data that has been prefetched, and the memory system 110 may output the data from the buffer to the host system 105. In some examples, outputting the data from the buffer may be in response to receiving a read command from the host system 105 and determining that data requested by the read command is present in the buffer. By predicting that sequential physical addresses are likely to be read by the host system 105 and loading these physical addresses into the buffer, the memory system 110 may support increased memory access speeds as a result of faster access speeds from the buffer relative to access speeds from one or more memory devices 130.

The system 100 may include any quantity of non-transitory computer readable media that support physical prefetch. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

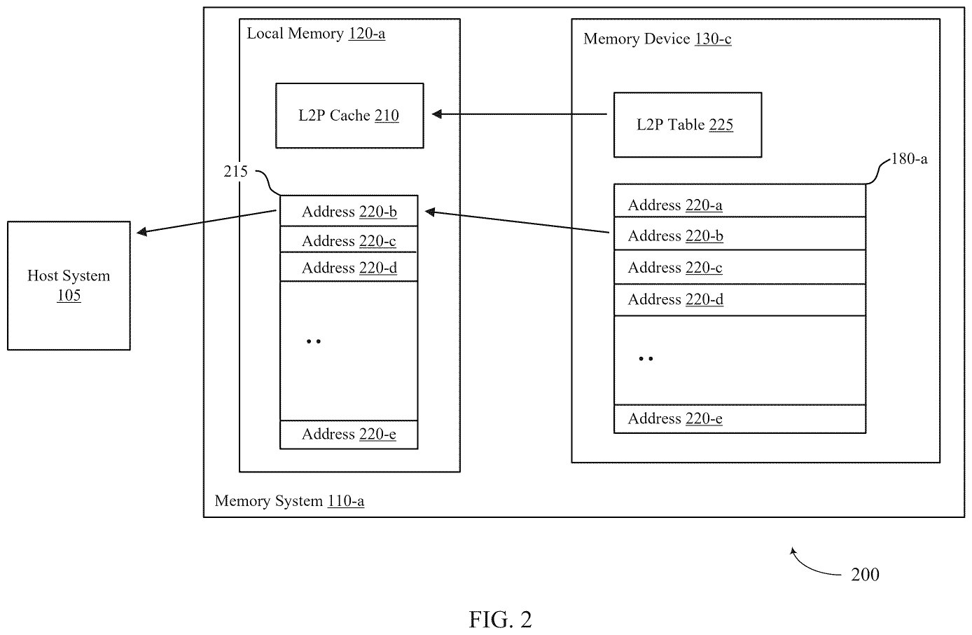

FIG. 2 shows an example of an architecture 200 that supports physical prefetch in accordance with examples as disclosed herein. The architecture 200 may implement or may be implemented by aspects of the system 100. For example, the architecture 200 may include a host system 105, a memory system 110-a, a local memory 120-a, a memory device 130-c, and a virtual block 180-a, which may be examples of corresponding systems, devices, and/or components described herein.

In some memory systems 110, data from a host system 105 may be written to a memory device 130-c such that data are stored in sequential physical addresses 220 of a virtual block 180-a. Though the data may be stored in sequential physical addresses 220, logical addresses (e.g., LBAs) associated with the sequential data may be fragmented (e.g., non-sequential). For example, in some memory systems, the memory system 110-a may initially store information in sequential logical addresses and sequential physical addresses. However, over time, the host system may use any available LBAs to store data, which may result in fragmentation of the sequential data across logical addressing block. In such an example, the data is still stored at the same physical address at the memory system, but the host system has adjusted the logical addressing space. A fragmented logical address space that is used to store data that is sequential in the physical address space may result in various inefficiencies for memory access. For example, the host system 105 may frequently request reads to the data (e.g., at the same time, in a same time window), and the memory system 110-a may load L2P information (e.g., portions of the L2P table 225, L2P table chunks) from the L2P table 225 to the L2P cache 210. However, the L2P cache 210 may be too small to store the entire L2P table 225, and the memory system 110-a may experience cache misses (e.g., L2P cache 210 misses) during reads of multiple non-sequential LBAs in the fragmented logical address space, which may result in relatively slow memory access speeds, latencies, and inefficient usage of processing resources.

In accordance with examples described herein, the memory system 110-a may prefetch data from physical addresses that are sequential to a physical address that has recently been read by the memory system 110-a. For example, the memory system 110-a may determine that a rate of access (e.g., a quantity of read operations over a duration) for the virtual block 180-a exceeds a threshold, and the memory system 110-a may prefetch the physically sequential data in response to the rate of access exceeding the threshold. An example of pre-fetching may include transferring the data from the physical address of a NAND memory device to a buffer (which may be an example of SRAM). In some examples, the memory system 110-a may receive a command to read an LBA corresponding to the physical address 220-a. The memory system 110-a may determine that, responsive to receiving the command, the rate of access to the virtual block 180-a exceeds the threshold. The memory system 110-a may determine one or more physical addresses 220 that are sequential to the physical address 220-a (e.g., a physical address 220-a, a physical address 220-a, and so on), and the memory system 110-a may transfer data from the one or more physical addresses 220 to a buffer 215 (e.g., a read lookahead buffer 215) in response to the rate of access to the virtual block 180-a exceeding the threshold.

After prefetching the data from the physical addresses 220 of the non-volatile device (e.g., NAND device) into the buffer 215 (e.g., SRAM), the memory system 110-a may receive subsequent read commands that request the data that has been prefetched (e.g., request data from LBAs corresponding to the prefetched physical addresses 220), and the memory system 110-a may output the data from the buffer 215 to the host system 105. In some examples, outputting the data from the buffer 215 may be in response to receiving a read command from the host system 105 and determining that data requested by the read command is present in the buffer 215. By predicting that sequential physical addresses 220 are likely to be read by the host system 105 and loading these physical addresses 220 into the buffer 215, the memory system 110-a may support increased memory access speeds as a result of faster access speeds from the buffer 215 relative to access speeds from the memory device 130-a. Reading data from NAND memory cells can take more time than reading data from SRAM. Thus, prefetching data from NAND into SRAM can reduce the latency to respond to a read command because transferring data from the SRAM to the host is faster than transferring data from the NAND to the host.

In some examples, a quantity of data (e.g., a quantity of physical addresses 220) that is prefetched is in accordance with the rate of access to the virtual block 180-a. For example, the memory system 110-a may determine a size of the buffer 215 (e.g., how much of the local memory 120-a is allocated to the buffer 215) dynamically in accordance with the rate of access to the virtual block 180-a. If the rate of access exceeds the threshold by a relatively small amount (e.g., fails to exceed a second threshold greater than the threshold), the memory system 110-a may allocate a relatively small area for the buffer 215 for prefetching for read commands. In such cases, the memory system 110-a may transfer data from a first quantity of physical addresses 220 (e.g., the physical address 220-b and the physical address 220-c). Alternatively, if the rate of access exceeds the threshold by a relatively larger amount (e.g., exceeds a second threshold greater than the threshold), the memory system 110-a may allocate a relatively large area for the buffer 215 for prefetching for read commands. In such cases, the memory system 110-a may transfer data from a second quantity of physical addresses 220 greater than the first quantity (e.g., the physical address 220-b, the physical address 220-c, the physical address 220-d, the physical address 220-e, additional physical addresses 220 between physical address 220-d and physical address 220-e). The memory system 110-a may use any quantity of thresholds for the rate of access to the virtual block 180-a, or any other criteria, for determining a size of the buffer 215 to dynamically allocate from the local memory 120-a.

In some examples, the memory system 110-a may determine that the rate of access to the virtual a may transfer L2P mapping information (e.g., portions of the L2P table 225) corresponding to the virtual block 180-a from the L2P table 225 of the memory device 130-c to the L2P cache 210. In some examples, the L2P table 225 may be stored in the virtual block 180-a. By loading the L2P mapping information for the virtual block 180-a into the L2P cache 210 in response to the rate of access to the virtual block 180-a exceeding the threshold, the memory system 110-a may support reduced cache misses and increased memory access speeds for read commands from the host system 105 that request data from the virtual block 180-a stored in sequential physical addresses 220.

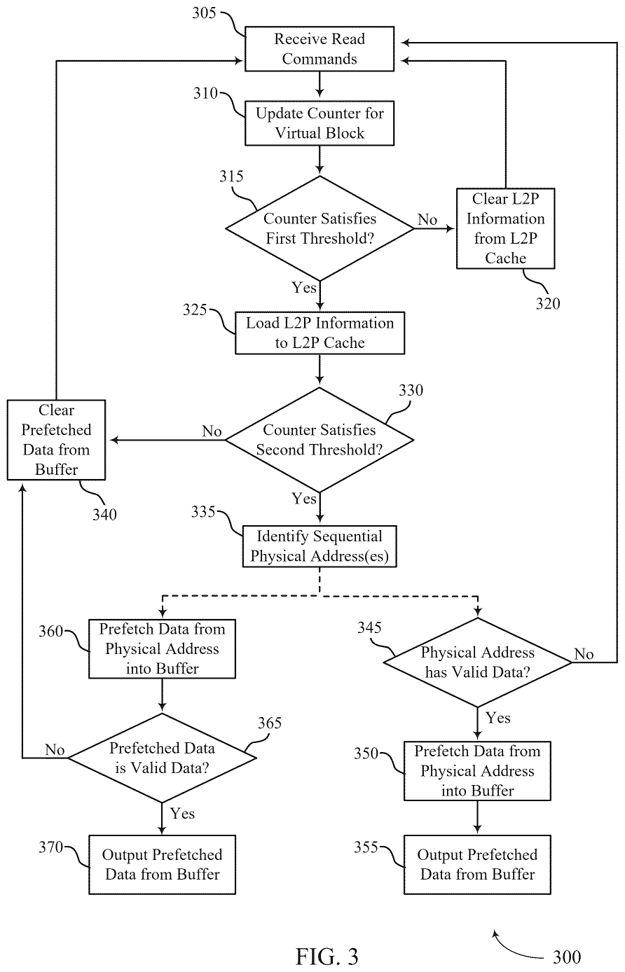

FIG. 3 shows an example of a process 300 that supports physical prefetch in accordance with examples as disclosed herein. The process 300 may implement aspects or operations of a system, which may be an example of a system 100, as described with reference to FIG. 1. For example, the process 300 may be implemented by a memory system, which may be an example of a memory system 110 (e.g., a memory system 110-a). In some cases, the process 300 may be facilitated by a memory system controller, which may be an example of a memory system controller 115. The process 300 may illustrate techniques for a physical prefetch procedure by a memory system, which may support reduced latency of memory access operations, thereby increasing system performance.

In the following description of the process 300, the methods, techniques, processes, and operations may be performed in different orders or at different times. Further, some operations may be left out of the process 300, or other operations may be added to the process 300. Aspects of the process 300 may be implemented by one or more controllers, among other components. Additionally, or alternatively, aspects of the process 300 may be implemented as instructions stored in one or more memories (e.g., volatile memory, non-volatile memory). For example, the instructions, when executed by one or more controllers (e.g., the memory system controller 115), may cause the one or more controllers (or a device or a system) to perform the operations of the process 300.

At 305, one or more read commands may be received that request data from a virtual block (e.g., a virtual block 180-a). For example, the memory system 110 (e.g., a memory system controller 115) may receive multiple read commands to the virtual block. The multiple read commands may include a first read command to read data from a first LBA of the virtual block and that corresponds to a first physical address.

At 310, a counter associated with the virtual block may be updated. For example, the memory system 110 (e.g., a memory system controller 115) may update the counter for the virtual block in response to receiving the multiple read commands to the virtual block. In some examples, a value of the counter may correspond to a rate of access to the virtual block. For example, the value of the counter may indicate a quantity of read commands received for the virtual block (e.g., or quantity of access operations performed on the virtual block) during (e.g., over) a time interval (e.g., a duration). The time interval (e.g., per n seconds, per n minutes, etc., where n is an interval) may be preconfigured at the memory system. The memory system (e.g., the memory system controller 115) may maintain and update respective counters for each virtual block of a set of virtual blocks (e.g., each virtual block of one or more memory devices 130), and each counter may correspond to a rate of access to the corresponding virtual block. In some examples, the memory system may store counters for the set of virtual blocks in volatile memory (e.g., in local memory 120).

In some examples, a value of the counter may be in accordance with a quantity of read commands that are received that request data from physically sequential addresses. In an example, the memory system may receive read commands and increment a counter for each instance of a read command requesting physically sequential data (e.g., relative to a previous read command). For example, the memory system may receive a second read command for a second LBA corresponding to a second physical address prior to receiving the first read command for the first LBA corresponding to the first physical address. The memory system may determine whether the first physical address (e.g., requested by the current read command) is sequential with the second physical address (e.g., requested by the prior read command). The memory system may increment the counter in response to the second physical address being sequential with the first physical address. Alternatively, the memory system may reset the counter (e.g., to zero) in response to the second physical address being non-sequential with the first physical address. Additionally, or alternatively, the memory system may determine a percentage of incoming read commands (e.g., from a host) that are requesting data that is sequential (e.g., physically sequential) to one or more previous read commands.

At 315, it may be determined whether the counter satisfies (e.g., exceeds) a first threshold. For example, the memory system (e.g., a memory system controller 115) may determine whether the value of the counter satisfies the first threshold in response to updating the counter. The first threshold may be preconfigured at the memory system. At 325, in response to the value of the counter satisfying the first threshold, L2P information corresponding to the virtual block may be transferred from the virtual block (e.g., or from elsewhere in a memory device 130) to an L2P cache. The L2P information may be maintained in the L2P cache until the access rate to the virtual block fails to satisfy the first threshold. For example, at 320, in response to the value of the counter failing to satisfy (e.g., dropping below) the first threshold, the L2P information corresponding to the virtual block may be cleared from the L2P cache. Loading the L2P information into the SRAM (e.g., the L2P cache portion of the SRAM) may be a technique to prepare the memory system for pre-fetching physical addresses. With additional L2P information included in the SRAM, the memory system may be better able to begin prefetching data once the second threshold is satisfied (e.g., at 330 and 335).

At 330, it may be determined whether the counter satisfies (e.g., exceeds) a second threshold greater than the first threshold. For example, the memory system (e.g., a memory system controller 115) may determine whether the value of the counter satisfies the second threshold in response to updating the counter and/or in response to determining that the counter satisfies the first threshold. The second threshold may be preconfigured at the memory system. At 335, in response to determining that the value of the counter satisfies the second threshold, one or more second physical addresses may be identified that are sequential (e.g., physically sequential) with the first physical address that is requested by the first read command. In some examples, at 340, data that has previously been prefetched into a buffer (e.g., a buffer 215, a read lookahead buffer) may be cleared from the buffer in response to the value of the counter failing to satisfy (e.g., dropping below) the second threshold.

One aspect of prefetching data from physical addresses may be determining whether the data being prefetched is valid data. One option is to blindly prefetch data from physical addresses without determining whether the data is valid or invalid. Later, using the metadata from the prefetched data, the memory system may be able to determine whether the data prefetched to the buffer is valid or not. Using blind pre-fetching is a simple algorithm. However, it can lead to wasted work. Different techniques are described for determining whether a data is valid or invalid.

In a first example, in response to identifying the second physical addresses sequential with the first physical address, a prefetch of data from the second physical addresses may be performed in accordance with steps 345 through 355. At 345, it may be determined whether the second physical addresses include (e.g., store) valid data. For example, the memory system (e.g., a memory system controller 115) may scan L2P mapping information for a second LBA corresponding to a second physical address and may determine, in accordance with the L2P mapping information, whether the second LBA corresponding to the second physical address maps to (e.g., points to) valid data. In some examples, the memory system may identify multiple second physical addresses sequential with the first physical address, and the memory system may perform data validation in accordance with the described techniques for each physical address of the multiple second physical addresses. Blindly scanning an L2P mapping for validity information for a physical address may take a long time and may not yield useful information if the logical address associated with the physical address is not included in that particular chunk of the L2P mapping.

Techniques for identifying whether prefetched data is valid or invalid is described. In a first example, the data may be prefetched (blindly) from the physical address in the NAND device to the buffer. The data may include metadata that may include the logical address associated with the data. Using the logical address identified after the data is retrieved, the memory system may be capable of determining whether data is valid or invalid using a page validity table (PVT) or an L2P mapping. If the data is invalid, the memory system may discard the invalid data. If the data is valid, the memory system may maintain the data in the buffer in preparation to receive a read command to request the data.

In a second example, the memory system may maintain and use a physical-to-logical (P2L) mapping to determine the validity of prefetched data. The memory system may identify the second physical address (e.g., or multiple second physical addresses) sequential with the first physical address but may be unaware of a logical address space that the second physical address corresponds to, and thus may be unaware of where the L2P information for the second physical address is located in memory and/or may be unable to identify the second LBA. Without the logical address for the second physical address, the memory system may be unable to determine whether the second physical address stores valid data. Thus, in some examples, the memory system may scan physical-to-logical (P2L) mapping to identify the second logical address (e.g., LBA) that corresponds to the second physical address. After the second logical address is identified, the memory system may use a PVT or the L2P to determine the validity of the data. In some cases, the memory system may transfer the L2P mapping information for the identified second LBA to the L2P cache, where the L2P information may be scanned to identify whether the second LBA maps to valid data.

In a third example, the memory system may store an L2P bitmap. The L2P bitmap may include multiple bits, and each bit may indicate a respective location of respective L2P mapping information for each portion (e.g., quantity of pages) of multiple portions of the virtual block. By reading the L2P bitmap, the memory system may identify a general location of L2P mapping information for the second physical address and may transfer the L2P information for the second physical address to the L2P cache. The L2P information may be scanned to identify whether the second logical address and may be used to determine validity of the data. In both the second and third example, if the data is invalid, the memory system may refrain from pre-fetching the invalid data. If the data is valid, the memory system may proceed with pre-fetching the valid data and storing it in the buffer.

In a fourth example, the memory system may check a block valid region table (BVRT). The BVRT may indicate whether a memory region (e.g., a 4 megabyte (MB) logic range of the memory system) has valid physical addresses in the prefetched data and discard invalid data or trigger table loading.

At 350, in response to determining that the second physical addresses include valid data, second data stored at the second physical addresses may be transferred from the virtual block (e.g., the NAND device) to a buffer (e.g., a buffer 215). In some examples, an amount of data (e.g., a size of the data, a quantity of physical addresses) transferred to the buffer at 350 may be in response to (e.g., may be scaled according to) a value of the counter that is updated at 310 (e.g., a rate of access to the virtual block). For example, a size of the buffer may be adjusted dynamically (e.g., in accordance with the value of the counter), and an amount of data from the second physical addresses may be transferred (e.g., prefetched) to the buffer until the buffer is full. In some examples, at 345, it may be determined that the second physical addresses include invalid data, and the process 300 may return to 305 where additional read commands may be received and where evaluation of the rate of access to the virtual block (e.g., for triggering future instances of physical prefetch) may proceed. In some examples, at 345, the memory system may determine that a first subset of the second physical addresses includes valid data and a second subset of the second physical addresses includes invalid data. In such examples, the memory system may transfer the valid data from the first subset of the multiple second physical addresses to the buffer and may refrain from transferring the invalid data from the second subset of the second physical addresses to the buffer.

At 355, in response to transferring the second data stored at the second physical addresses to the buffer, the second data may be output from the buffer. For example, the memory system (e.g., a memory system controller 115) may receive a read command to read the second data from a second LBA corresponding to the second physical address (e.g., or from a set of second LBAs corresponding to multiple second physical addresses), and the memory system may output the second data from the buffer in response to the read command. In some examples, the memory system may determine that the data requested by the read command is present in the buffer, and the memory system may output the data from the buffer (e.g., instead of from a memory device) in response to the determination that the requested data is present in the buffer.

In a second example, in response to identifying the second physical addresses sequential with the first physical address, a prefetch of data from the second physical addresses may be performed in accordance with steps 360 through 370. At 360, in response to identifying the second physical addresses that are sequential with the first physical address, second data stored at the second physical addresses may be transferred from the virtual block to a buffer (e.g., a buffer 215). In some examples, the prefetch at 360 may be referred to herein as a blind prefetch (e.g., the memory system may transfer the second data to the buffer prior to determining that the second data includes valid data). In some examples, an amount of data (e.g., a size of the data, a quantity of physical addresses) transferred to the buffer at 360 may be in response to (e.g., may be scaled according to) a value of the counter that is updated at 310 (e.g., a rate of access to the virtual block). For example, a size of the buffer may be adjusted dynamically (e.g., in accordance with the value of the counter), and an amount of data from the second physical addresses may be transferred (e.g., prefetched) to the buffer until the buffer is full.

At 365, it may be determined whether the second data transferred to the buffer includes valid data. For example, the memory system (e.g., a memory system controller 115) may read, after transferring the second data to the buffer, metadata included in the second data that indicates a second LBA corresponding to the second physical address (e.g., or a set of second LBAs corresponding to the multiple second physical addresses). The memory system may scan L2P mapping information (e.g., at an L2P cache) associated with the second LBA (e.g. or set of second LBAs) indicated by the metadata to determine whether the second data transferred to the buffer includes valid data.

In some examples, at 365, it may be determined that the second data transferred to the buffer includes invalid data, and the second data may be cleared from the buffer at 340. In some examples, at 365, the memory system may determine that a first subset of the second data transferred to the buffer includes valid data and a second subset of the second data transferred to the buffer includes invalid data. In such examples, the memory system may maintain the first subset of the second data in the buffer and may clear the second subset of the data from the buffer.

At 370, in response to determining that the second data transferred to the buffer includes valid data, the second data may be output from the buffer. For example, the memory system (e.g., a memory system controller 115) may receive a read command to read the second data from a second LBA corresponding to the second physical address (e.g., or from a set of second LBAs corresponding to multiple second physical addresses), and the memory system may output the second data from the buffer in response to the read command. In some examples, the memory system may determine that the data requested by the read command is present in the buffer, and the memory system may output the data from the buffer (e.g., instead of from a memory device) in response to the determination that the requested data is present in the buffer.

In accordance with these and other examples, a memory system may perform physical prefetch to support increased memory access speeds when servicing requests from a host system for sequential (e.g., physically sequential) data stored in memory. For example, access speeds from the buffer may be faster relative to access speeds from memory devices (e.g., from NAND memory). Thus, by transferring data, identified by the memory system as physically sequential to one or more previous (e.g., recent) read commands, from the memory devices to the buffer, the memory system may support relatively faster access speeds for physically sequential data (e.g., from the second physical addresses), thereby increasing throughput and reducing latency (e.g., for relatively low queue depth workloads).

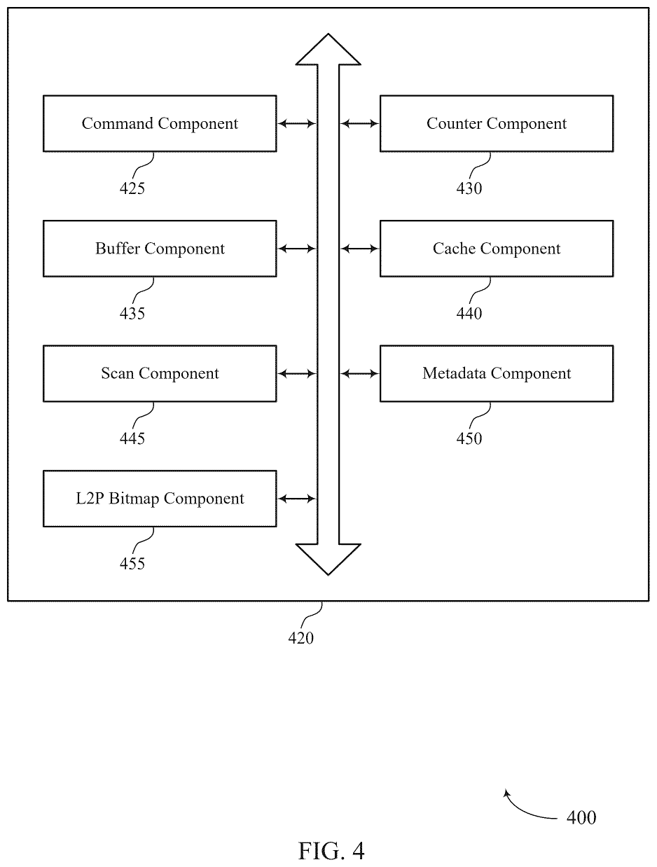

FIG. 4 shows a block diagram 400 of a memory system 420 that supports physical prefetch in accordance with examples as disclosed herein. The memory system 420 may be an example of aspects of a memory system as described with reference to FIGS. 1 through 3. The memory system 420, or various components thereof, may be an example of means for performing various aspects of physical prefetch as described herein. For example, the memory system 420 may include a command component 425, a counter component 430, a buffer component 435, a cache component 440, a scan component 445, a metadata component 450, a L2P bitmap component 455, or any combination thereof. Each of these components, or components of subcomponents thereof (e.g., one or more processors, one or more memories), may communicate, directly or indirectly, with one another (e.g., via one or more buses).

The command component 425 may be configured as or otherwise support a means for receiving a plurality of read commands associated with a virtual block, where the plurality of read commands includes a first read command to read first data from a first logical block address of the virtual block that corresponds to a first physical address. The counter component 430 may be configured as or otherwise support a means for updating a counter associated with the virtual block in response to receiving the plurality of read commands. The buffer component 435 may be configured as or otherwise support a means for transferring, from the virtual block to a buffer, second data associated with a second physical address that is sequential with the first physical address in response to a value of the counter satisfying a threshold.

In some examples, the counter component 430 may be configured as or otherwise support a means for determining whether the value of the counter associated with the virtual block satisfies a second threshold, where the second threshold is different than the threshold. In some examples, the cache component 440 may be configured as or otherwise support a means for transferring, from the virtual block to a cache in response to the value of the counter satisfying the second threshold, logical-to-physical mapping information corresponding to the virtual block, where the second physical address is identified in response to transferring the logical-to-physical mapping information.

In some examples, the command component 425 may be configured as or otherwise support a means for receiving, as part of receiving the plurality of read commands and prior to receiving the first read command, a second read command to read third data from a second logical block address of the virtual block that corresponds to a third physical address. In some examples, the counter component 430 may be configured as or otherwise support a means for determining whether the first physical address associated with the first read command is sequential with the third physical address associated with the second read command, where updating the counter is in response to determining that the first physical address is sequential with the third physical address.

In some examples, the scan component 445 may be configured as or otherwise support a means for scanning logical-to-physical mapping information associated with a second logical block address corresponding to the second physical address. In some examples, the scan component 445 may be configured as or otherwise support a means for determining whether the second physical address includes valid data in response to scanning the logical-to-physical mapping information associated with the second logical block address, where transferring the second data associated with the second physical address to the buffer is in response to determining that the second physical address includes valid data.

In some examples, the scan component 445 may be configured as or otherwise support a means for scanning physical-to-logical mapping information associated with the second physical address to identify the second logical block address corresponding to the second physical address. In some examples, the cache component 440 may be configured as or otherwise support a means for transferring, from the virtual block to a cache, the logical-to-physical mapping information associated with the second logical block address, where scanning the logical-to-physical mapping information associated with the second logical block address is in response to transferring the logical-to-physical mapping information.

In some examples, the L2P bitmap component 455 may be configured as or otherwise support a means for reading a logical-to-physical bitmap to identify a location of second logical-to-physical mapping information within the virtual block, the second logical-to-physical mapping information including the logical-to-physical mapping information associated with the second logical block address, where each bit of a plurality of bits included in the logical-to-physical bitmap indicates a respective location of respective logical-to-physical mapping information associated with each portion of a plurality of portions of the virtual block. In some examples, the cache component 440 may be configured as or otherwise support a means for transferring, from the identified location within the virtual block to a cache, the second logical-to-physical mapping information, where scanning the logical-to-physical mapping information associated with the second logical block address is in response to transferring the second logical-to-physical mapping information that includes the logical-to-physical mapping information.

In some examples, the metadata component 450 may be configured as or otherwise support a means for reading, after transferring the second data associated with the second physical address to the buffer, metadata included in the second data that indicates a second logical block address corresponding to the second physical address. In some examples, the scan component 445 may be configured as or otherwise support a means for scanning logical-to-physical mapping information associated with the second logical block address corresponding to the second physical address. In some examples, the scan component 445 may be configured as or otherwise support a means for determining whether the second physical address includes valid data in response to scanning the logical-to-physical mapping information associated with the second logical block address.

In some examples, the buffer component 435 may be configured as or otherwise support a means for outputting the second data from the buffer in response to determining that the second physical address includes valid data.

In some examples, the buffer component 435 may be configured as or otherwise support a means for clearing the second data from the buffer in response to determining that the second physical address includes invalid data.

In some examples, the command component 425 may be configured as or otherwise support a means for receiving, after transferring the second data associated with the second physical address to the buffer, a second read command to read the second data from a second logical block address corresponding to the second physical address. In some examples, the buffer component 435 may be configured as or otherwise support a means for outputting, from the buffer, the second data in response to receiving the second read command.

In some examples, the command component 425 may be configured as or otherwise support a means for receiving, after transferring the second data associated with the second physical address to the buffer, one or more second read commands to read third data outside of the virtual block. In some examples, the counter component 430 may be configured as or otherwise support a means for updating the counter associated with the virtual block in response to receiving the one or more second read commands. In some examples, the buffer component 435 may be configured as or otherwise support a means for clearing, from the buffer, the second data associated with the second physical address in response to the value of the counter failing to satisfy the threshold.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

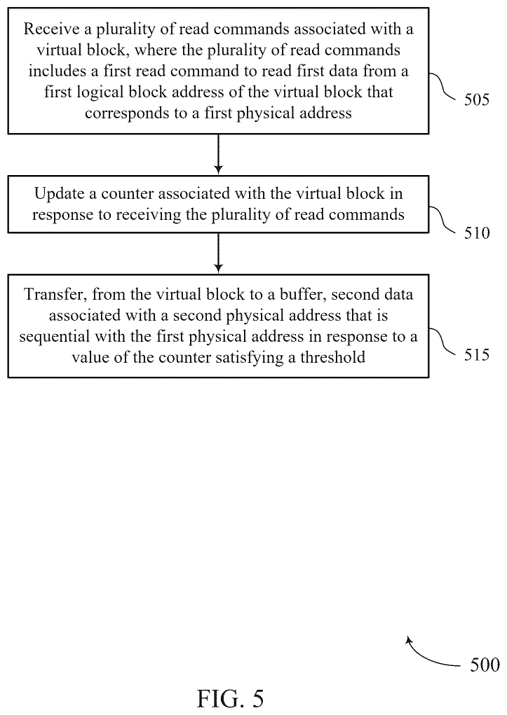

FIG. 5 shows a flowchart illustrating a method 500 that supports physical prefetch in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a plurality of read commands associated with a virtual block, where the plurality of read commands includes a first read command to read first data from a first logical block address of the virtual block that corresponds to a first physical address. In some examples, aspects of the operations of 505 may be performed by a command component 425 as described with reference to FIG. 4.

At 510, the method may include updating a counter associated with the virtual block in response to receiving the plurality of read commands. In some examples, aspects of the operations of 510 may be performed by a counter component 430 as described with reference to FIG. 4.

At 515, the method may include transferring, from the virtual block to a buffer, second data associated with a second physical address that is sequential with the first physical address in response to a value of the counter satisfying a threshold. In some examples, aspects of the operations of 515 may be performed by a buffer component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a plurality of read commands associated with a virtual block, where the plurality of read commands includes a first read command to read first data from a first logical block address of the virtual block that corresponds to a first physical address; updating a counter associated with the virtual block in response to receiving the plurality of read commands; and transferring, from the virtual block to a buffer, second data associated with a second physical address that is sequential with the first physical address in response to a value of the counter satisfying a threshold.

Aspect 2: The method, apparatus, or non-transitory computer-readable medium of aspect 1, further including operations, features, circuitry, logic, means, or instructions, or any combination thereof for determining whether the value of the counter associated with the virtual block satisfies a second threshold, where the second threshold is different than the threshold and transferring, from the virtual block to a cache in response to the value of the counter satisfying the second threshold, logical-to-physical mapping information corresponding to the virtual block, where the second physical address is identified in response to transferring the logical-to-physical mapping information.

Aspect 3: The method, apparatus, or non-transitory computer-readable medium of any of aspects 1 through 2, further including operations, features, circuitry, logic, means, or instructions, or any combination thereof for receiving, as part of receiving the plurality of read commands and prior to receiving the first read command, a second read command to read third data from a second logical block address of the virtual block that corresponds to a third physical address and determining whether the first physical address associated with the first read command is sequential with the third physical address associated with the second read command, where updating the counter is in response to determining that the first physical address is sequential with the third physical address.

Aspect 4: The method, apparatus, or non-transitory computer-readable medium of any of aspects 1 through 3, further including operations, features, circuitry, logic, means, or instructions, or any combination thereof for scanning logical-to-physical mapping information associated with a second logical block address corresponding to the second physical address and determining whether the second physical address includes valid data in response to scanning the logical-to-physical mapping information associated with the second logical block address, where transferring the second data associated with the second physical address to the buffer is in response to determining that the second physical address includes valid data.

Aspect 5: The method, apparatus, or non-transitory computer-readable medium of aspect 4, further including operations, features, circuitry, logic, means, or instructions, or any combination thereof for scanning physical-to-logical mapping information associated with the second physical address to identify the second logical block address corresponding to the second physical address and transferring, from the virtual block to a cache, the logical-to-physical mapping information associated with the second logical block address, where scanning the logical-to-physical mapping information associated with the second logical block address is in response to transferring the logical-to-physical mapping information.

Aspect 6: The method, apparatus, or non-transitory computer-readable medium of any of aspects 4 through 5, further including operations, features, circuitry, logic, means, or instructions, or any combination thereof for reading a logical-to-physical bitmap to identify a location of second logical-to-physical mapping information within the virtual block, the second logical-to-physical mapping information including the logical-to-physical mapping information associated with the second logical block address, where each bit of a plurality of bits included in the logical-to-physical bitmap indicates a respective location of respective logical-to-physical mapping information associated with each portion of a plurality of portions of the virtual block and transferring, from the identified location within the virtual block to a cache, the second logical-to-physical mapping information, where scanning the logical-to-physical mapping information associated with the second logical block address is in response to transferring the second logical-to-physical mapping information that includes the logical-to-physical mapping information.

Aspect 7: The method, apparatus, or non-transitory computer-readable medium of any of aspects 1 through 6, further including operations, features, circuitry, logic, means, or instructions, or any combination thereof for reading, after transferring the second data associated with the second physical address to the buffer, metadata included in the second data that indicates a second logical block address corresponding to the second physical address; scanning logical-to-physical mapping information associated with the second logical block address corresponding to the second physical address; and determining whether the second physical address includes valid data in response to scanning the logical-to-physical mapping information associated with the second logical block address.

Aspect 8: The method, apparatus, or non-transitory computer-readable medium of any of aspects 1 through 7, further including operations, features, circuitry, logic, means, or instructions, or any combination thereof for outputting the second data from the buffer in response to determining that the second physical address includes valid data.

Aspect 9: The method, apparatus, or non-transitory computer-readable medium of any of aspects 1 through 8, further including operations, features, circuitry, logic, means, or instructions, or any combination thereof for clearing the second data from the buffer in response to determining that the second physical address includes invalid data.

Aspect 10: The method, apparatus, or non-transitory computer-readable medium of any of aspects 1 through 9, further including operations, features, circuitry, logic, means, or instructions, or any combination thereof for receiving, after transferring the second data associated with the second physical address to the buffer, a second read command to read the second data from a second logical block address corresponding to the second physical address and outputting, from the buffer, the second data in response to receiving the second read command.

Aspect 11: The method, apparatus, or non-transitory computer-readable medium of any of aspects 1 through 10, further including operations, features, circuitry, logic, means, or instructions, or any combination thereof for receiving, after transferring the second data associated with the second physical address to the buffer, one or more second read commands to read third data outside of the virtual block; updating the counter associated with the virtual block in response to receiving the one or more second read commands; and clearing, from the buffer, the second data associated with the second physical address in response to the value of the counter failing to satisfy the threshold.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a plurality of read commands associated with a virtual block, wherein the plurality of read commands comprises a first read command to read first data from a first logical block address of the virtual block that corresponds to a first physical address;
update a counter associated with the virtual block in response to receiving the plurality of read commands; and
transfer, from the virtual block to a buffer, second data associated with a second physical address that is sequential with the first physical address in response to a value of the counter satisfying a threshold.

2. The memory system of claim 1, wherein the processing circuitry is further configured to cause the memory system to:
determine whether the value of the counter associated with the virtual block satisfies a second threshold, wherein the second threshold is different than the threshold; and
transfer, from the virtual block to a cache in response to the value of the counter satisfying the second threshold, logical-to-physical mapping information corresponding to the virtual block, wherein the second physical address is identified in response to transferring the logical-to-physical mapping information.

3. The memory system of claim 1, wherein the processing circuitry is further configured to cause the memory system to:
receive, as part of receiving the plurality of read commands and prior to receiving the first read command, a second read command to read third data from a second logical block address of the virtual block that corresponds to a third physical address; and
determine whether the first physical address associated with the first read command is sequential with the third physical address associated with the second read command, wherein updating the counter is in response to determining that the first physical address is sequential with the third physical address.

4. The memory system of claim 1, wherein the processing circuitry is further configured to cause the memory system to:
scan logical-to-physical mapping information associated with a second logical block address corresponding to the second physical address; and
determine whether the second physical address comprises valid data in response to scanning the logical-to-physical mapping information associated with the second logical block address, wherein transferring the second data associated with the second physical address to the buffer is in response to determining that the second physical address comprises valid data.

5. The memory system of claim 4, wherein the processing circuitry is further configured to cause the memory system to:
scan physical-to-logical mapping information associated with the second physical address to identify the second logical block address corresponding to the second physical address; and
transfer, from the virtual block to a cache, the logical-to-physical mapping information associated with the second logical block address, wherein scanning the logical-to-physical mapping information associated with the second logical block address is in response to transferring the logical-to-physical mapping information.

6. The memory system of claim 4, wherein the processing circuitry is further configured to cause the memory system to:
read a logical-to-physical bitmap to identify a location of second logical-to-physical mapping information within the virtual block, the second logical-to-physical mapping information including the logical-to-physical mapping information associated with the second logical block address, wherein each bit of a plurality of bits included in the logical-to-physical bitmap indicates a respective location of respective logical-to-physical mapping information associated with each portion of a plurality of portions of the virtual block; and
transfer, from the identified location within the virtual block to a cache, the second logical-to-physical mapping information, wherein scanning the logical-to-physical mapping information associated with the second logical block address is in response to transferring the second logical-to-physical mapping information that includes the logical-to-physical mapping information.

7. The memory system of claim 1, wherein the processing circuitry is further configured to cause the memory system to:
read, after transferring the second data associated with the second physical address to the buffer, metadata included in the second data that indicates a second logical block address corresponding to the second physical address;
scan logical-to-physical mapping information associated with the second logical block address corresponding to the second physical address; and
determine whether the second physical address comprises valid data in response to scanning the logical-to-physical mapping information associated with the second logical block address.

8. The memory system of claim 1, wherein the processing circuitry is further configured to cause the memory system to:
output the second data from the buffer in response to determining that the second physical address comprises valid data.

9. The memory system of claim 1, wherein the processing circuitry is further configured to cause the memory system to:
clear the second data from the buffer in response to determining that the second physical address comprises invalid data.

10. The memory system of claim 1, wherein the processing circuitry is further configured to cause the memory system to:
receive, after transferring the second data associated with the second physical address to the buffer, a second read command to read the second data from a second logical block address corresponding to the second physical address; and
output, from the buffer, the second data in response to receiving the second read command.

11. The memory system of claim 1, wherein the processing circuitry is further configured to cause the memory system to:
receive, after transferring the second data associated with the second physical address to the buffer, one or more second read commands to read third data outside of the virtual block;
update the counter associated with the virtual block in response to receiving the one or more second read commands; and
clearing, from the buffer, the second data associate with the second physical address in response to the value of the counter failing to satisfy the threshold.

12. A non-transitory computer-readable medium comprising instructions which, when executed by processing circuitry of a memory system, cause the memory system to:
receive a plurality of read commands associated with a virtual block, wherein the plurality of read commands comprises a first read command to read first data from a first logical block address of the virtual block that corresponds to a first physical address;
update a counter associated with the virtual block in response to receiving the plurality of read commands; and
transfer, from the virtual block to a buffer, second data associated with a second physical address that is sequential with the first physical address in response to a value of the counter satisfying a threshold.

13. The non-transitory computer-readable medium of claim 12, wherein the instructions, when executed by the processing circuitry of the memory system, further cause the memory system to:
determine whether the value of the counter associated with the virtual block satisfies a second threshold, wherein the second threshold is different than the threshold; and
transfer, from the virtual block to a cache in response to the value of the counter satisfying the second threshold, logical-to-physical mapping information corresponding to the virtual block, wherein the second physical address is identified in response to transferring the logical-to-physical mapping information.

14. The non-transitory computer-readable medium of claim 12, wherein the instructions, when executed by the processing circuitry of the memory system, further cause the memory system to:
receive, as part of receiving the plurality of read commands and prior to receiving the first read command, a second read command to read third data from a second logical block address of the virtual block that corresponds to a third physical address; and
determine whether the first physical address associated with the first read command is sequential with the third physical address associated with the second read command, wherein updating the counter is in response to determining that the first physical address is sequential with the third physical address.

15. The non-transitory computer-readable medium of claim 12, wherein the instructions, when executed by the processing circuitry of the memory system, further cause the memory system to:
scan logical-to-physical mapping information associated with a second logical block address corresponding to the second physical address; and
determine whether the second physical address comprises valid data in response to scanning the logical-to-physical mapping information associated with the second logical block address, wherein transferring the second data associated with the second physical address to the buffer is in response to determining that the second physical address comprises valid data.

16. The non-transitory computer-readable medium of claim 15, wherein the instructions, when executed by the processing circuitry of the memory system, further cause the memory system to:
scan physical-to-logical mapping information associated with the second physical address to identify the second logical block address corresponding to the second physical address; and
transfer, from the virtual block to a cache, the logical-to-physical mapping information associated with the second logical block address, wherein scanning the logical-to-physical mapping information associated with the second logical block address is in response to transferring the logical-to-physical mapping information.

17. The non-transitory computer-readable medium of claim 15, wherein the instructions, when executed by the processing circuitry of the memory system, further cause the memory system to:
read a logical-to-physical bitmap to identify a location of second logical-to-physical mapping information within the virtual block, the second logical-to-physical mapping information including the logical-to-physical mapping information associated with the second logical block address, wherein each bit of a plurality of bits included in the logical-to-physical bitmap indicates a respective location of respective logical-to-physical mapping information associated with each portion of a plurality of portions of the virtual block; and
transfer, from the identified location within the virtual block to a cache, the second logical-to-physical mapping information, wherein scanning the logical-to-physical mapping information associated with the second logical block address is in response to transferring the second logical-to-physical mapping information that includes the logical-to-physical mapping information.

18. The non-transitory computer-readable medium of claim 12, wherein the instructions, when executed by the processing circuitry of the memory system, further cause the memory system to:
read, after transferring the second data associated with the second physical address to the buffer, metadata included in the second data that indicates a second logical block address corresponding to the second physical address;
scan logical-to-physical mapping information associated with the second logical block address corresponding to the second physical address; and
determine whether the second physical address comprises valid data in response to scanning the logical-to-physical mapping information associated with the second logical block address.

19. The non-transitory computer-readable medium of claim 12, wherein the instructions, when executed by the processing circuitry of the memory system, further cause the memory system to:
output the second data from the buffer in response to determining that the second physical address comprises valid data.

20. The non-transitory computer-readable medium of claim 12, wherein the instructions, when executed by the processing circuitry of the memory system, further cause the memory system to:
clear the second data from the buffer in response to determining that the second physical address comprises invalid data.

21. The non-transitory computer-readable medium of claim 12, wherein the instructions, when executed by the processing circuitry of the memory system, further cause the memory system to:
receive, after transferring the second data associated with the second physical address to the buffer, a second read command to read the second data from a second logical block address corresponding to the second physical address; and
output, from the buffer, the second data in response to receiving the second read command.

22. The non-transitory computer-readable medium of claim 12, wherein the instructions, when executed by the processing circuitry of the memory system, further cause the memory system to:
receive, after transferring the second data associated with the second physical address to the buffer, one or more second read commands to read third data outside of the virtual block;
update the counter associated with the virtual block in response to receiving the one or more second read commands; and
clearing, from the buffer, the second data associate with the second physical address in response to the value of the counter failing to satisfy the threshold.

23. A method by a memory system, comprising:
receiving a plurality of read commands associated with a virtual block, wherein the plurality of read commands comprises a first read command to read first data from a first logical block address of the virtual block that corresponds to a first physical address;
updating a counter associated with the virtual block in response to receiving the plurality of read commands; and
transferring, from the virtual block to a buffer, second data associated with a second physical address that is sequential with the first physical address in response to a value of the counter satisfying a threshold.
